(19) United States
(12) Patent Application Publication
(10) Pub. No.: US 2008/0285176 A1
(43) Pub. Date: Nov. 20, 2008

(54) STORAGE DEVICE

(75) Inventor: Yoshihiro Arikawa, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/183,264

(22) Filed: Jul. 31, 2008

Related U.S. Application Data
(63) Continuation of application No. PCT/JP2006/301999, filed on Feb. 6, 2006.

(51) Int. Cl. G11B 5/54; G11B 33/14

(52) U.S. Cl. 360/254.8; 360/97.02

(57) ABSTRACT

A storage device includes a head configured to record information in or reproduce the information from a recording medium, a suspension configured to support the head, a lift tab provided onto the suspension, a ramp, which the lift tab elastically contacts, the lift tab being configured to slide on the ramp, the ramp being configured to support the lift tab so as to hold the head at a position apart from the recording medium in loading the head over the recording medium and in unloading the head from the recording medium, and a heating member provided outside the ramp at a position close to the ramp.

This application is a continuation based on PCT International Application No. PCT/JP2006/301999, filed on Feb. 6, 2006, which is hereby incorporated by reference herein in its entirety as if fully set forth herein.

### BACKGROUND OF THE INVENTION

The present invention relates generally to a storage device, and more particularly to a storage device having a ramp that holds a head at a position apart from a recording medium. The storage device of the present invention is suitable, for example, for a hard disc drive (“HDD”).

Along with the recent rapid developments of the Internet etc., an available electronic information amount has explosively increased. Therefore, larger-capacity magnetic storage devices, typified by HDDs, have been increasingly demanded to store a large amount of information. In the HDD, a slider mounted with a head floats over a disc for recording and reproducing actions. A relationship between the slider and the disc in rotating and stopping the disc is classified into a contact start stop (“CSS”) system in which the slider contacts the disc, and a ramp or dynamic loading system in which the slider retreats from the disc in stopping the disc and is held by a holding member called a ramp.

In the CSS system, the slider is likely to be absorbed onto the disc, and a texture process that forms fine convexes and concaves on the disc surface is required to prevent the absorptions. This texture process increases cost, and becomes hard to practice particularly due to a reduced floating amount of the slider in the recent higher recording density and the associative demands for the flat disc surface.

Accordingly, the ramp loading system has recently attracted attentions. The ramp loading system holds the slider in a non-contact manner from the disc in starting and stopping rotations of the disc, and thus causes no friction that would otherwise damage the disc or no absorption between them. The ramp loading system has additional advantages in that no texture process is required and the head floating amount can be reduced. In the ramp loading system, a lift tab at the top of a suspension that supports the slider contacts the ramp with an elastic force and slides on a sliding surface on the ramp in loading the slider over the disc and unloading the slider from the disc.

Prior art includes Japanese Patent Publication Applications Nos. 2000-367313, 2004-95009, and 2005-158097.

However, the ramp loading system typically makes the ramp of polyacetar or liquid crystal polymer and the suspension of metal. As a result, there is a problem in that abrasive powder occurs due to abrasions when the lift tab repetitively slides on the ramp. The abrasive powder adheres to the suspension and drops on the disc when the slider is loaded over the disc, and adheres to the slider that is moving above the disc. The abrasive powder is not welcome because it may possibly cause crashes between the slider and the disc.

### BRIEF SUMMARY OF THE INVENTION

Accordingly, it is an exemplary object of the present invention to provide a storage device that provides stable recording and reproducing actions by reducing dangers of crashes between the slider and the disc.

The present invention provides a liquid crystal display apparatus that can avoid the influence by the accumulated charged particles in the liquid crystal layer without adding a new member such as the switching part or the ion trap electrode to the liquid crystal modulation element.

The present invention according to one aspect of the present invention is a storage device. The storage device includes a head configured to record information in or reproduce the information from a recording medium, a suspension configured to support the head, a lift tab provided onto the suspension, a ramp, which the lift tab elastically contacts, the lift tab being configured to slide on the ramp, the ramp being configured to support the lift tab so as to hold the head at a position apart from the recording medium in loading the head over the recording medium and in unloading the head from the recording medium, and a heating member provided outside the ramp at a position close to the ramp. The ramp is worn away more conspicuously at the low temperature. In particular, at the starting time of use of the storage device, such as a power-on time and a running time from the sleeping mode, the storage device is not sufficiently heated. When the head is loaded over the recording medium in the low temperature environment as a result of that the lift tab slides on the ramp, the abrasion is likely to occur. The storage device is gradually heated due to use of the motor, etc., and becomes in the room temperature environment. Then, the abrasion naturally reduces. Accordingly, the heating member is provided near the ramp so as to heat the vicinity of the ramp at the starting time of use of the storage device under the low temperature environment and to then load the head over the disc (or unload the lift tab from the ramp), thereby reducing the ramp's abrasion.

In addition, at the starting time of use, the head has been loaded onto the ramp and the lift tab has been held on the ramp. Therefore, both of the ramp and the lift tab can be simultaneously heated, and the abrasion that would otherwise occur when the lift tab slides on the ramp can be effectively prevented when the lift tab is unloaded from the ramp. In addition, a position of the heating member may be in the middle between the lift tab held by the ramp and the ramp.

The heater is arranged outside the ramp but close to the ramp. In general, the ramp is made of a material, such as polyacetar and liquid crystal polymer, and the heating member mounted on the ramp can deform the ramp when provides heating, lowering the dimension precision of the ramp.

The storage device may further include a circuit board mounted with an exoergic circuit element, wherein the ramp is provided on a first surface of the circuit board, and the exoergic circuit element is provided at a position on a second surface of the circuit board corresponding to the ramp, the second surface being opposite to the first surface of the circuit board. This structure utilizes the conventionally provided exoergic circuit element, such as an IC, and can prevent the abrasion of the ramp without providing the heating member as a new component. The exoergic circuit element may be provided at a position on the second surface corresponding to the ramp or at a position in the middle between the ramp and the lift tab held on the ramp. Therefore, the position of the exoergic circuit element is not limited.

The storage device may further include a temperature measurement part configured to measure a temperature of or around the ramp, and a controller configured to control a heating action by the heating member based on a measurement result by the temperature measurement part. Thereby, the controller can drive the heating member only at the low temperature time, such as in winter or at night, so as to save the power. In addition, the ramp is not excessively heated and a deformation of the ramp can be prevented.

The controller may control the heating action by the heating member so that the temperature measurement part can measure a room temperature. Since the ramp is generally designed to have a given dimension at the room temperature (25° C.), the controller can maintain the dimension precision of the ramp.

Another aspect of the present invention is a temperature control method used for a storage device that includes a head configured to record information in or reproduce the information from a recording medium, a suspension configured to support the head, a lift tab provided onto the suspension, and a ramp, which the lift tab elastically contacts, the lift tab being configured to slide on the ramp, the ramp being configured to support the lift tab so as to hold the head at a position apart from the recording medium in loading the head over the recording medium and in unloading the head from the recording medium. The temperature control method includes controlling a temperature of the ramp or an ambient temperature around the ramp before the head is loaded over the recording medium at a starting time of use of the storage device.

Other aspects of the present invention will become apparent from the following description and the attached drawings.

### BRIEF DESCRIPTION OF THE DRAWINGS

FIG. 1 is a plane view showing an internal structure of a hard disc drive (“HDD”) as one example of a storage device according to one aspect of the present invention.

FIG. 2 is an enlarged perspective view of a slider of the HDD shown in FIG. 1.

FIG. 3 is an enlarged perspective view of a ramp in the HDD shown in FIG. 1.

FIG. 4 is an enlarged plane view of the ramp in the HDD shown in FIG. 1.

FIG. 5 is a graph showing an abrasion amount of the ramp shown in FIG. 1 for each ambient temperature.

FIG. 6 is a block diagram of a temperature control system utilizing the heating member shown in FIG. 1.

FIG. 7 is a plane view as a variation of the heat shown in FIG. 1.

### DETAILED DESCRIPTION OF THE EMBODIMENTS

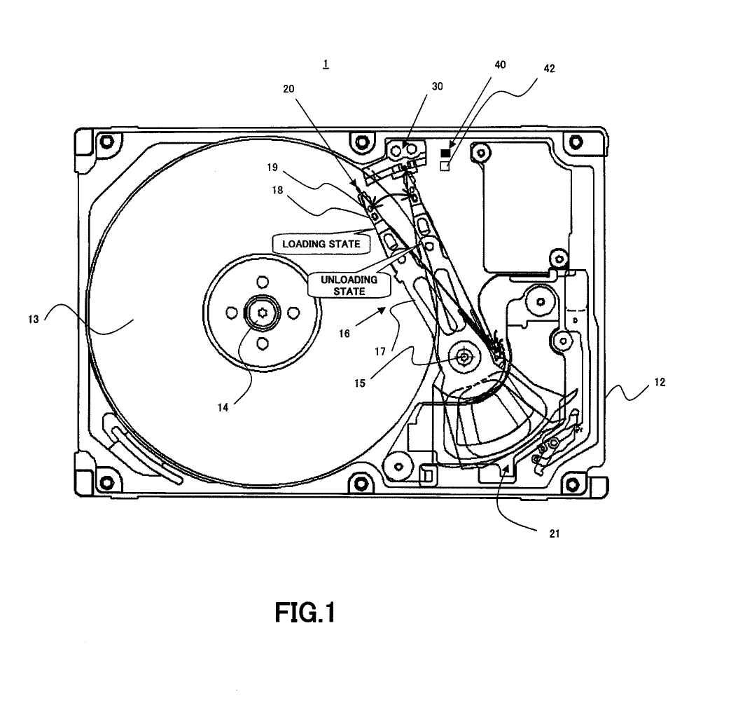

Referring now to the accompanying drawings, a description will be given of an HDD 1 according to one aspect of the present invention. The HDD 1 includes, as shown in FIG. 1, one or more magnetic discs 13 as a recording medium, a spindle motor 14, a magnetic head part, a ramp 30, and a heating member 40 in a housing 12. FIG. 1 is a schematic plane view of the internal structure of the HDD 1. In this embodiment, the number of magnetic discs 13 is illustratively one.

The housing 12 is made, for example, of aluminum die casting or stainless steel, and has a rectangular parallelepiped shape to which a cover (not shown) is coupled so as to seal its internal space. The magnetic disc 13 of this embodiment has a high recording density, such as 100 Gb/in² or higher, and is mounted on a spindle of the spindle motor 14 through a central hole.

The spindle motor 14 rotates the magnetic disc 13 at a high speed, such as 10,000 rpm, and includes a brushless DC motor (not shown) and a spindle as its rotor part. For example, when two magnetic discs 13 are used, a disc, a spacer, a disc, and a clamp are stacked in this order on the spindle, and fixed by a bolt engaged with the spindle.

The magnetic head part includes a slider 19, and an actuator 16 that serves as a mechanism for positioning and driving the slider 19.

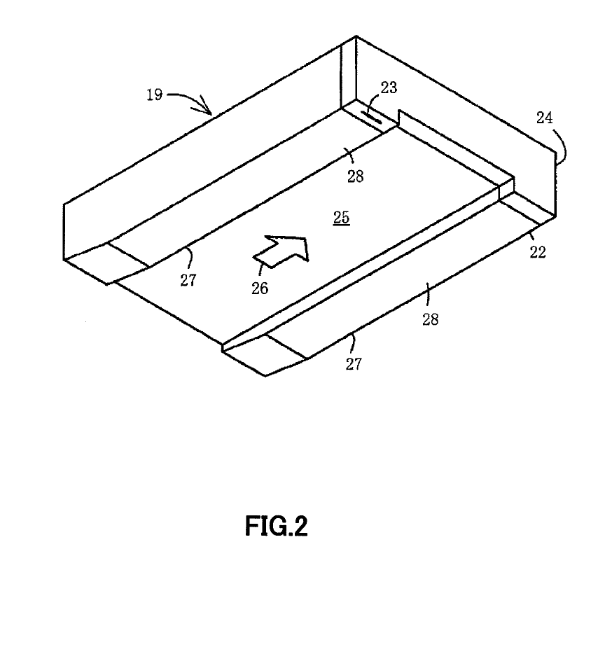

The slider 19 includes, as shown in FIG. 2, a slider body 22 having an approximately rectangular parallelepiped shape made of Al₂O₃—TiC (altic), and a head-device built-in film 24 united with at an air outflow end of the slider body 22 and made of Al₂O₃ (alumina). The film 24 contains a built-in read/write head 23. FIG. 2 is an enlarged perspective view of the slider 19. The slider body 22 and head-device built-in film 24 define a floatation surface 25 as a surface opposite to a medium, i.e., the magnetic disc 13, for catching air current 26 generated from the rotating magnetic disc 13.

A pair of rails 27 extends on the floatation surface 25 from an air inflow end to the air outflow end. A so-called air-bearing surface (referred to as “ABS” hereinafter) 28 is defined at a top surface of each rail 27. The floating force is generated at the ABS 28 according to an act of the air current 26. The head 23 embedded in the head-device built-in film 24 exposes at the ABS 28. The floatation system of the slider 19 is not limited to this form, but may use a known dynamic pressure lubricating system, a known static pressure lubricating system, a known piezoelectric control system, and any other known floatation system. As discussed below, this embodiment uses a ramp loading system that retreats or unloads the slider 19 from the disc 13 before the disc 13 stops, holds the slider 19 on the ramp 30 located outside the disc 13 in a non-contact manner between the slider 19 and the disc 13, and drops or load the slider 19 from the holding part over the disc 13 when the disc 13 is run.

The head 23 includes a magnetoresistive (“MR” hereinafter)/inductive composite head that contains an inductive head device for writing binary information into the magnetic disc 13 using a magnetic field induced by a conductive coil pattern (not shown), and a MR head device for reading resistance as binary information changing according to a magnetic field generated by the magnetic disc 13. The MR head device may use any type, such as a giant magnetoresistive (“GMR”) type including both a Current in Plane (“CIP”) structure and a Current Perpendicular to Plane (“CPP”) structure, a tunneling magnetoresistive type (“TMR”) and an anisotropic magnetoresistive (“AMR”) type.

Turning back to FIG. 1, the actuator 16 includes the voice coil motor 21, a support shaft 15, and a carriage 17.

The voice coil motor 21 includes can use any technology known in the art, and a detailed description thereof will be omitted. For example, the voice coil motor 21 includes a permanent magnet fixed onto an iron plate fixed in the housing 12, and mobile magnets fixed and arranged in opposite direction between the carriage arm 17 and the support shaft 15. The support shaft 15 is inserted into a cylindrical hollow hole in the carriage arm 17, and arranged such that it extends perpendicular to the paper surface in FIG. 1 in the housing 12.

The carriage arm 17 can rotate or swing around the support shaft 15, and has the suspension 18 at its tip. The suspension 18 can be made, for example, of stainless steel, which uses a gimbal spring (not shown) to cantilever the slider 19 and a lift tab 20 at the tip. The suspension 18 has a wiring part that is connected to the slider 19 via gold ball bonding (“GBB”) etc. The wiring part is omitted in FIG. 1. The sense current, read-in data, and read-out data are supplied and output between the head 23 and the wiring part through the GBB. The suspension 18 applies an elastic force to the slider 19 and the lift tab 20 against the surface of the magnetic disc 13.

The lift tab 20 is provided on the tip of the suspension 18, and, for example, integrated with the suspension 18 and made of the same material as the suspension 18. The lift tab 20 slides on the ramp 30 and serves to load and unload the slider 19. In other words, the lift tab 20 loads the slider 19 from the ramp 30 over the magnetic disc 13 after driving of the magnetic disc 13 starts, and unloads the slider 19 from the magnetic disc 13 to the ramp 30 so as to hold the slider 19 on the ramp 30 before driving of the magnetic disc 13 stops.

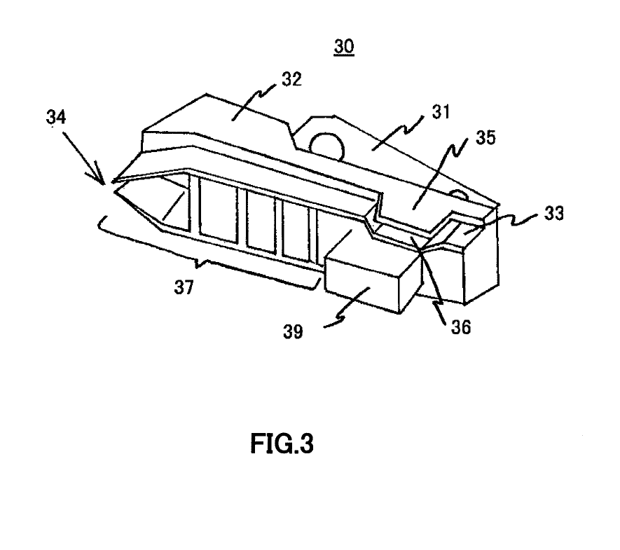

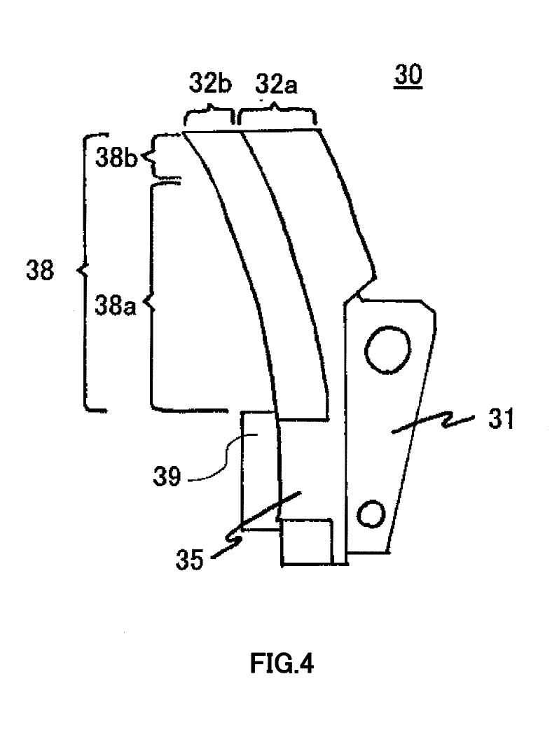

Referring to FIGS. 1, 3 and 4, the ramp 30 is provided near the outermost circumference of the magnetic disc 13, and part of the ramp 30 projects over the magnetic disc 13. FIGS. 3 and 4 are enlarged perspective and plane views of the ramp 30, respectively. While this embodiment conveniently describes the ramp 30 used for the lift tabs on the front and back sides of one magnetic disc 13, the present invention is not limited to this embodiment.

Referring to FIGS. 3 and 4, the ramp 30 includes a fixture part 31 fixed on a bottom surface of the housing 12 via screws, a base 32 coupled with the fixture part 31 and arranged outside the magnetic disc 13, and a guide part 33 that guides and holds the lift tab 20 and contacts the lift tab 20 slidably. An outermost circumference of the magnetic disc 13 is partially inserted into a U-shaped groove 34 formed at the top of the guide part 33.

The base 32 includes a cover 35 that prevents the lift tab 20 from vibrating and deviating from a holding part 36, which will be described later. The cover 35 may extend over the sliding surface 38.

The guide part 33 includes the holding part 36, a sliding part 37, and a pressure plate 39. While the holding part 36 and the sliding surface 38 are also formed at the lower side of the guide part 33, and used for another lift tab (not shown), only the upper side will be discussed for convenience.

The holding part 36 is a recess that holds the lift tab 20 that supports the slider 19, and the holding part 36 serves as a home position for the lift tab 20 in the ramp 120. The recess of the holding part 36 has a U shape that slightly opens at both sides in this embodiment, but may use another shape, such as a V shape.

The sliding part 37 has a sliding surface 38 arranged at a height such that the lift tab 20 can contact the sliding surface 37 with a predetermined elastic force. The sliding surface 38 has, as shown in FIG. 4, an arc shape with a predetermined width corresponding to an arc locus drawn by the lift tab 20, and includes a flat part 38a and an inclined part 38b. The flat part 38a is connected to the holding part 36, and extends parallel to a surface of the magnetic disc 13. The inclined surface 38b that inclines from the flat part 38a to the magnetic disc 13 partially projects above the magnetic disc 13.

The pressure plate 39 projects from the body, and has a square rod shape, and has upper and lower surfaces that are approximately parallel to the surface of the magnetic disc 13. The pressure plate 39 serves to restrain the fluctuations of the gimbal and the slider 19.

The heating member 40 serves to heat both the lift tab 20 and the ramp 30. Prior to the installation of the heating member 40, the instant inventor investigated a relationship between the temperature and the abrasion of the ramp 30 and the lift tab 20.

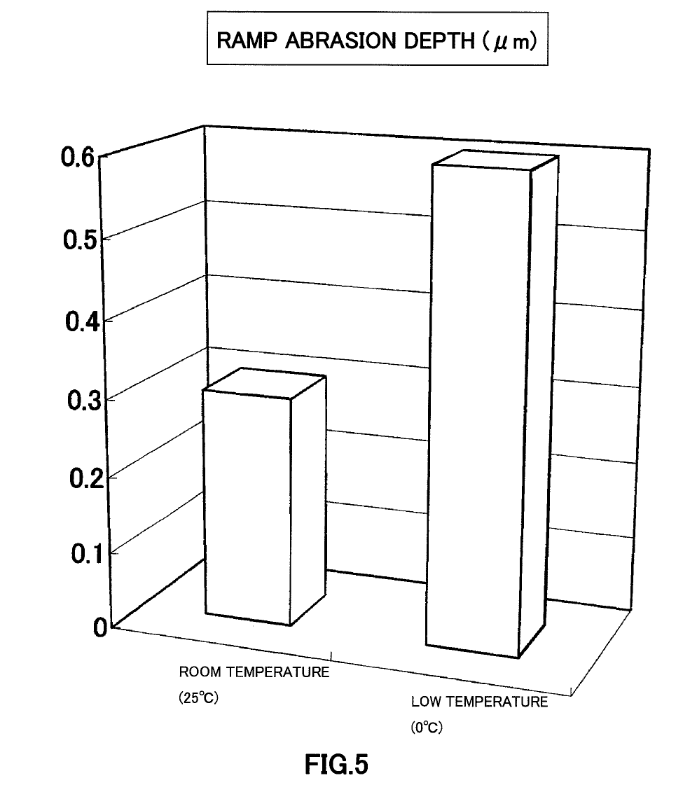

The inventor investigated abrasion depths of the sliding surface 38 of the ramp 30 at the room temperature (25° C.) and at the low temperature (0° C.) after the lift tab 20 is loaded onto and unloaded from the ramp 30 1,000,000 times, and obtained a result shown in FIG. 5. In FIG. 5, the ordinate axis denotes an abrasion depth of the ramp 30 (μm), and the abscissa axis denotes temperature. It is understood from FIG. 5 that the abrasion of the ramp 30 at the low temperature is about 0.6 μm, which is larger than 0.3 μm of the abrasion of the ramp 30 at the room temperature.

In addition, the experiment shown in FIG. 5 put the HDD in a temperature controlled bath ramp 30, and maintained the temperature of the temperature controlled bath at the temperature shown in FIG. 5. It is thus understood that the abrasion reduces when the heating member 40 heats the ambient temperature around the ramp 30 from the low temperature to or above the room temperature. The experiment shown in FIG. 5 indicates a difference of the ramp's abrasion due to the environmental temperature, and does not directly describe the effect of the present invention. The present invention allows a rise of the temperature only around the ramp, and thus the presumable result would be obtained between the abrasion at the room temperature and the abrasion at the low temperature.

When the heating member 40 is sophisticated enough to heat the entire interior of the HDD, the heating member 40 does not have to be arranged near the ramp, but this configuration will increase cost and power consumption. Therefore, this embodiment uses a heating member that is small enough to heat the lift tab and the ramp and their surrounding in the ramp loading and arranges the heating member near the ramp.

The heating member 40 may heat only the sliding part 37 on which the lift tab 20 slides, rather than the entire ramp 30, because abrasion powder occurs on the sliding surface 38. After the head is loaded, the abrasion between the lift tab 20 and the ramp 30 stops and thus it is sufficient to heat the lift tab 20 only while the lift tab 20 is contacting the ramp 30.

The heating member 40 is arranged outside the ramp 30. The ramp 30 is typically made of a material, such as polyacetar and liquid crystal polymer, and when the heating member 40 is mounted on the ramp 30, the ramp is deformed and its dimension accuracy may deteriorate. This embodiment arranges the heating member 40 opposite to the ramp 30 with respect to the disc 13, as shown in FIG. 1. However, the present invention does not eliminate a configuration that mounts the heating member 40 on the ramp 30 via a member that mitigates heating by the heating member 40.

The heating member 40 of this embodiment is a heater. A type of the heater is not limited, but the heating member 40 does not have to be configured as a heater as an independent member.

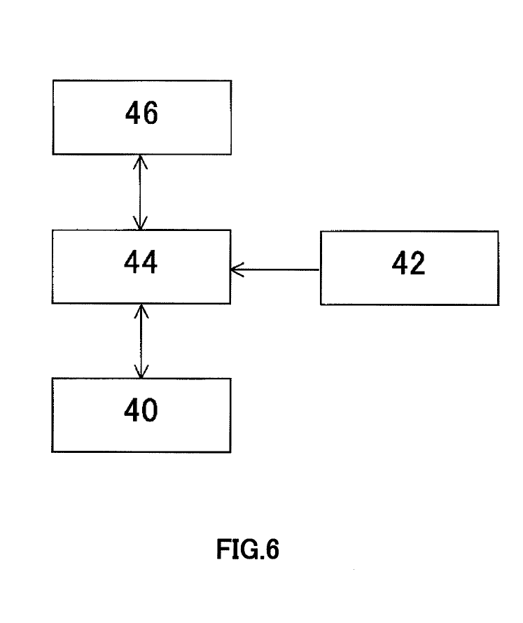

As shown in FIGS. 1 and 6, the temperature control system that utilizes the heating member 40 may use a temperature sensor 42, a controller 44, and a memory 46. FIG. 6 is a block diagram of the temperature control system. The temperature sensor 42 measures the temperatures of both the lift tab 20 and the ramp 30 or their environmental temperature. The temperature sensor 42 is located near the heating member 40 in FIG. 1, but the position of the temperature sensor 42 is not limited as long as it can measure the environmental temperature.

The controller 44 controls a heating action of the heating member 40 based on the result of the temperature sensor 42. The memory 46 stores information of the temperature or temperature range to be controlled. The controller 44 and the memory 46 are, for example, mounted on a circuit board 50. The controller 44 compares the temperature measured by the temperature sensor 42 with the temperature stored in the memory 46, and controls the heating action of the heating member 40 (e.g., electrification to the heating member 40) based on the comparison result. Thereby, the controller 44 can drive the heating member 40 only at the low temperature time, such as in winter or at night, so as to save the power. The ramp 30 is not always heated, and the ramp's deformation can be prevented and the dimension accuracy can be maintained.

The target environmental temperature stored in the memory 46 may be the room temperature (25° C.). Since the ramp 30 is designed to have a given dimension at the room temperature (25° C.), the dimension accuracy deteriorates at any temperature lower or higher than the room temperature. Since the dimension variance is approximately linear in this case, the controller 44 can maintain the dimension accuracy of the ramp 30 through feedback control over the environmental temperature to the room temperature.

Instead of the controller 44 and the memory 46, the temperature sensor 42 sends a detection signal when detecting the predetermined temperature, such as 25° C., and heating of the heating member 40 may be kept continuing while the detection signal is being transmitted. It is thus sufficient that the heater 40 provides control such that the temperatures of the lift tab 20 and the ramp 30 do not become lower than the predetermined temperature.

Instead of an expensive temperature sensor, a timer may be used for heating control that is provided a predetermined time (enough to reach the room temperature environment) after use of the HDD begins.

It is necessary for the heating control of the heating member 40 to initially heat the ramp and its vicinity so as to obtain the temperature environment of the room temperature or above before the head is loaded over the recording medium, at the starting time of use of the HDD under the low temperature environment, such as a power-on time and a resume time from the sleep mode. Thereafter, the entire HDD is heated by use of the motor, etc., and the temperature environment of the room temperature or above is obtained. Then, heating is no longer necessary and thus heating by the heating member 40 is stopped. It is less likely that loading and unloading are repetitively performed many times in the normal use mode before the temperature in the HDD rises up to the room temperature or above due to the motor and the circuit board. In the HDD in the use environment that does not frequently repeat the ramp loading, heating by the heating member may be stopped immediately after the initial head loading.

In loading the lift tab onto the ramp below the room temperature some time after the HDD is run, the lift tab is spaced from the heating member and thus only the ramp is heated in the heating. In unloading the lift tab from the ramp below the room temperature some time after the HDD is run, the lift tab is held by the ramp and the lift tab and the ramp can be simultaneously heated. When the lift tab is frequently loaded onto and unloaded from the ramp, heating may continue up to the room temperature. In the HDD in which the lift tab is not frequently loaded onto and unloaded from the ramp, heating may be provided temporarily rather than continuous heating or heating for a predetermined time period. The heating control may be adjusted according to use environment of the HDD.

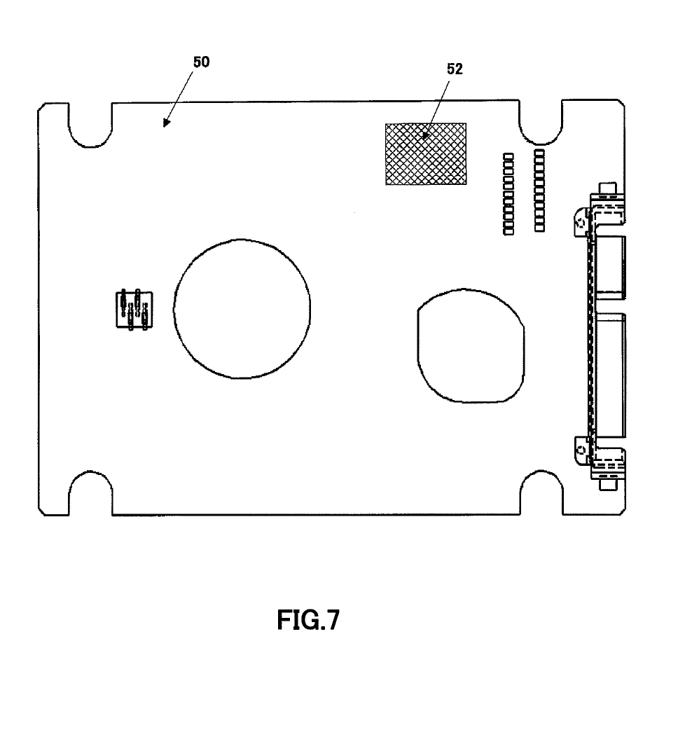

The heater 40 may use an exoergic circuit element, such as an IC and an LSI, which is conventionally provided on the circuit board 50. FIG. 7 is a plane view of the embodiment that uses the IC 52 mounted on the circuit board 50 for the heating member 40. This embodiment provides the ramp 30 on the front surface of the circuit board 50 (opposite to the surface shown in FIG. 7), and the IC 52 on the back surface of the circuit board 50 (which is the surface shown in FIG. 7). This is because it is difficult to arrange both members on the same plane due to the arrangement restrictions, and a contact between the ramp 30 and the IC 52 is prevented so as to maintain the dimension accuracy. This embodiment provides the IC 52 at a position on the back surface of the circuit board 50 corresponding to the ramp, but the position is not limited as long as the lift tab 20 and the ramp 30 are heated. For example, the IC 52 may be arranged at a position on the back surface of the circuit board 50 corresponding to the heating member 40 shown in FIG. 1. This embodiment can prevent the abrasion of the ramp 30 without providing a heating member as a new component.

The HDD 1 includes, as a control system (not shown) a controller (which may be the controller 44), an interface, a hard disc controller (referred to as “HDC” hereinafter), a write modulator, a read demodulator, and a head IC. The controller covers any processor such as a CPU and MPU irrespective of its name, and controls each part in the control system. The interface connects the HDD 1 to an external apparatus, such as a personal computer (“PC” hereinafter) as a host. The HDC sends to the controller data that has been demodulated by the read demodulator, sends data to the write modulator. The HDC may be the controller 44. The controller or HDC provides servo control over the spindle motor 14 and (a motor in) the actuator 16. The write modulator modulates data and supplies data to the head IC, which data has been supplied from the host through the interface and is to be written down onto the magnetic disc 13 by an inductive head. The read demodulator demodulates data into an original signal by sampling data read from the magnetic disc 13 by the MR head device. The write modulator and read demodulator may be recognized as one signal processor. The head IC serves as a preamplifier.

In operation of the HDD 1, the controller (not shown) drives the spindle motor 14 and rotates the disc 13 in response to an instruction of the host, etc. The controller then controls the actuator 16 and rotates the carriage arm 17 around the support shaft 15. Initially, the lift tab 20 is held by the holding part 36 of the ramp 30, but the rotation of the actuator 16 moves the lift tab 20 from the holding part 36 to the sliding surface 38.

Next, the lift tab 20 moves to the disc 13 through the flat part 38, and the head 23 is then sought onto a target track on the magnetic disc 13. In this unloading time, the heater 40 has heated the lift tab 20 and the ramp 30 (preferably up to the room temperature), and thus reduces the abrasion and crashes that would otherwise occur due to the abrasive powder.

The airflow associated with the rotation of the magnetic disc 13 is introduced between the disc 13 and slider 19, forming a fine air film and generating a floating force that enables the slider 19 to float over the disc surface. On the other hand, the suspension 18 applies the elastic pressure onto the slider 19 in the direction against the floating force of the slider 19. The balance between the floating force and the elastic force spaces the slider 19 from the disc 13 by a constant distance.

In a write time, the controller (not shown) receives data from the host through the interface, selects the inductive head device, and sends data to the write modulator through the HDC. In response, the write modulator modulates the data, and sends the modulated data to the head IC. The head IC amplifies the modulated data, and then supplies the data as write current to the inductive head device. Thereby, the inductive head device writes down the data onto the target track.

In a read time, the controller (not shown) selects the MR head device, and sends the predetermined sense current to the sense-current controller through the HDC. Data is amplified by the head IC based on the electric resistance of the MR head device varying according to a signal magnetic field, and is then supplied to the read demodulator to be demodulated to an original signal. The demodulated signal is sent to the host (not shown) through the HDC, controller, and interface.

This embodiment can maintain a wide effective recording area of the disc by reducing a projection amount of the ramp body over the disc 13.

When the read and write end, the controller controls the actuator 16 and rotates the carriage arm 17 around the support shaft 15 from the inner circumference to the outer circumference on the magnetic disc 13. Thereby, the lift tab 20 is unloaded from the magnetic disc 13, and moves along the sliding surface 38 and held at the holding part 36. At the holding part 36, the cover 35 restricts a perpendicular movement of the lift tab 2. The pressure plate 39 opposes to the gimbal by a constant aperture, and restricts an abnormal displacement of the gimbal, or an abnormal displacement of the slider 19.

The controller (not shown) controls the spindle motor 14 and stops the rotation of the magnetic disc 13. Unlike the CSS system, the ramp loading system is less likely to cause crashes when driving of the magnetic disc 13 starts, since the slider 19 does not apply the frictional force to the disc 13.

Further, the present invention is not limited to the preferred embodiment, and various modifications and changes may be made in the present invention without departing from the spirit and scope thereof. For example, the number of holding parts 36 and the number of sliding surfaces 38 are variable in the ramp 30 depending upon the number of discs 13 and the number of sliders 19. A type of the inventive recording medium is not limited to a magnetic disc, and the present invention is applicable to optical (thermal) recording media.

Thus, the present invention can provide a storage device that provides stable recording and reproducing actions by reducing dangers of crashes between the slider (or head) and the disc.

What is claimed is:

1. A storage device comprising:
a head configured to record information in or reproduce the information from a recording medium;
a suspension configured to support the head;
a lift tab provided onto the suspension;
a ramp, which the lift tab elastically contacts, the lift tab being configured to slide on the ramp, the ramp being configured to support the lift tab so as to hold the head at a position apart from the recording medium in loading the head over the recording medium and in unloading the head from the recording medium; and
a heating member provided outside the ramp at a position close to the ramp.

2. The storage device according to claim 1, further comprising a circuit board mounted with an exoergic circuit element,
wherein the ramp is provided on a first surface of the circuit board, and the exoergic circuit element is provided at a position on a second surface of the circuit board corresponding to the ramp, the second surface being opposite to the first surface of the circuit board.

3. The storage device according to claim 1, further comprising:
a temperature measurement part configured to measure a temperature of or around the ramp; and
a controller configured to control a heating action by the heating member based on a measurement result by the temperature measurement part.

4. The storage device according to claim 1, wherein the controller controls the heating action by the heating member so that the temperature measurement part can measure a room temperature.

5. A temperature control method used for a storage device that includes:
a head configured to record information in or reproduce the information from a recording medium;
a suspension configured to support the head;
a lift tab provided onto the suspension; and
a ramp, which the lift tab elastically contacts, the lift tab being configured to slide on the ramp, the ramp being configured to support the lift tab so as to hold the head at a position apart from the recording medium in loading the head over the recording medium and in unloading the head from the recording medium,
said temperature control method comprising controlling a temperature of the ramp or an ambient temperature around the ramp before the head is loaded over the recording medium at a starting time of use of the storage device.
